(19) United States
(12) Patent Application Publication
(10) Pub. No.: US 2026/0056433 A1
(43) Pub. Date: Feb. 26, 2026

(54) LIQUID CRYSTAL DISPLAY MODULE

(71) Applicant: PowerView Display Corporation, Hsinchu County (TW)

(72) Inventor: Wen-Ling HSIAO, Hsinchu County (TW)

(21) Appl. No.: 18/809,385

(22) Filed: Aug. 20, 2024

(51) Int. Cl. G02F 1/1335; G02F 1/1333; G02F 1/13357

(52) U.S. Cl. CPC G02F 1/133628; G02F 1/133308; G02F 1/133526; G02F 1/133608; G02F 2202/28

(57) ABSTRACT

A liquid crystal display module includes a backlight unit, an LCD panel, a front cover and a cover lens. The LCD panel is disposed above the backlight unit. The front cover covers a top side of a heat sink of the backlight unit. A lateral side of the front cover is in contact with an outer sidewall of the heat sink. The front cover is not in contact with the LCD panel. The cover lens is adhered on the front cover through an adhesive material. The LCD panel is adhered on the cover lens through an optical clear resin. Moreover, at least one fastening hole is formed in the lateral side of the front cover.

### FIELD OF THE INVENTION

The present invention relates to a display device, and more particularly to a liquid crystal display module.

### BACKGROUND OF THE INVENTION

Nowadays, many electronic products are equipped with display devices. The display device usually includes a liquid crystal display module. FIG. 1A and FIG. 1B schematically illustrate the applications of display modules.

As shown in FIG. 1A, a liquid crystal display module 110 is embedded in the back of an airplane seat for passengers to enjoy various programs in the airplane. Generally, this liquid crystal display module 110 is a detachable liquid crystal display module. For example, due to the economic consideration or the shorter flight, the liquid crystal display module 110 can be removed from the back of the seat by the airline.

As shown in FIG. 1B, the display device on the medical instrument can also be equipped with the display module 120. Of course, the display module can be installed in more places. For example, the display module can be installed on the dashboard of a car, the control panel of a processing machine or any other appropriate electronic product.

FIG. 2A is a schematic perspective view illustrating a conventional display module. FIG. 2B is a schematic cross-sectional view illustrating the structure of the display module shown in FIG. 2A and taken along the line AB. The display module 200 includes a front cover 220, a backlight unit 250, an LCD panel 240, a cover lens 210 and an optical clear resin (OCR) 230. The LCD panel 240 is an in-plane-switching liquid crystal panel (also referred as an IPS panel). The front cover 220 is a metal front cover. The backlight unit 250 includes a heat sink 260, a backlight source 252 and a frame 254. The frame 254 is a plastic frame. The sidewall of the backlight source 252 is surrounded by the frame 254.

As shown in FIG. 2B, in backlight unit 250, the backlight source 252 is in contact with the bottom surface of the concave structure of the heat sink 260. The frame 254 is in contact with the inner sidewall of the heat sink 260. Furthermore, the frame 254 includes a supporting part 258. The LCD panel 240 is placed on the supporting part 258 of the frame 254. The backlight source 252 is arranged between the bottom side of the supporting part 258 and the bottom surface of the concave structure of the heat sink 260. In other words, the bottom side and the lateral sides of the backlight source 252 are respectively surrounded by the heat sink 260 and the frame 254. Consequently, the light beam emitted by the backlight source 252 can only be projected to the outside of the display module 200 through the LCD panel 240.

The front cover 220 covers the top side of the heat sink 260, the top side of the frame 254 and the outer edge of the LCD panel 240. In addition, the lateral sides of the front cover 220 are in contact with the outer sidewall of the heat sink 260. An opening is formed in a surface of the front cover 220. The LCD panel 240 is exposed to the opening. Generally, plural screw holes 222, 224 and 226 are formed in the lateral sides of the front cover 220. After corresponding screws (not shown) are penetrated through the screw holes 222, 224 and 226, the screws are penetrated through the heat sink 260 and tightened into the frame 254 of the backlight unit 250. In other words, the front cover 220 and the backlight unit 250 are combined together through the screws. As mentioned above, the outer edge of the LCD panel 240 is covered by the front cover 220. Consequently, after the front cover 220 and the backlight unit 250 are combined together through the screws, the front cover 220 is also contacted with the LCD panel 240 to fix the LCD panel 240.

In order to protect the LCD panel 240, the cover lens 210 can be used to cover the top side of the front cover 220 and the top side of the LCD panel 240. As shown in FIG. 2B, the optical clear resin (OCR) 230 is applied to the top surface of the front cover 220 and the top surface of the LCD panel 240, and then the resulting structure is covered with the cover lens 210. Consequently, the cover lens 210 is adhered on the surface of the front cover 220 through the optical clear resin (OCR) 230. Furthermore, the space between the cover lens 210 and the LCD panel 240 is also filled with the optical clear resin (OCR) 230. That is, after the cover lens 210 is adhered on the top surface of the front cover 220 and the top surface of the LCD panel 240 through the optical clear resin (OCR) 230, the display module 200 is completed.

As mentioned above, the display module 200 includes plural screw holes 222, 224 and 226. After the display module 200 is placed on a fixing bracket (not shown), the display module 200 can be fixed on the fixing bracket through screws (not shown). For example, the back of the airplane seat is a fixing bracket. In addition, the display module 200 is fixed on the back of the airplane seat in a screwing manner. Similarly, the display module 200 may be assembled on a medical instrument or an electronic product.

FIG. 3 is a schematic cross-sectional view illustrating a process of screwing the display module on the fixing bracket according to prior art. Firstly, the display module 200 shown in FIG. 2B is placed on a fixing bracket 310. Then, screws 322 and 324 are penetrated through corresponding screw holes of the fixing bracket 310 and the screw holes 222 and 224 and tightened into the front cover 220 by the operator. Consequently, the front cover 220 is fixed in the fixing bracket 310 in the screwing manner. However, the conventional process of screwing the display module still has some drawbacks. For example, there is a tolerance gap d between the fixing bracket 310 and the display module 200. Due to the tolerance gap d, the front cover 220 is possibly pulled in response to the stress on the fixing bracket 310 when the display module 200 is screwed on the fixing bracket 310. Consequently, the fixing bracket 310 and the front cover 220 will be suffered from the screwing deformation problem. Generally, the magnitude of the force applied to the screws 322 and 324 by the operator influences the screwing deformation level. In case that the magnitude of the force applied to the screws 322 and 324 by the operator is large, the screwing deformation will be more serious.

Please refer to FIG. 3 again. In case that the front cover 220 is suffered from the screwing deformation problem, the front cover 220 will exert a greater force on the edge 350 of the LCD panel 240 in response to the stress compression. When an image is displayed on the display module 200, the force-receiving point at the edge 350 of the LCD panel 240 will result in an obvious Mura phenomenon because the front cover 220 continuously presses the edge 350 of the LCD panel 240. Under this circumstance, the displayed image is suffered from image distortion or uneven brightness. When the user views the displayed image, the Mura phenomenon makes the visual experience worse. In addition, the user thinks that the display module 200 is damaged or faulty.

### SUMMARY OF THE INVENTION

An embodiment of the present invention provides a liquid crystal display module. The liquid crystal display module includes a backlight unit, an LCD panel, a front cover and a cover lens. The backlight unit includes a heat sink, a backlight source and a frame. A lateral side of the backlight source is surrounded by the frame. The backlight source is in contact with a surface the heat sink. The frame is in contact with an inner sidewall of the heat sink. The LCD panel is disposed above the backlight unit. The front cover covers a top side of the heat sink and a top side of the frame. A lateral side of the front cover is in contact with an outer sidewall of the heat sink. An opening is formed in the front cover, and the LCD panel is exposed to the opening. The front cover is not in contact with the LCD panel. The cover lens covers a top side of the front cover and a top side of the LCD panel. The cover lens is adhered on the front cover through an adhesive material. The LCD panel is adhered on the cover lens through an optical clear resin. Moreover, at least one fastening hole is formed in the lateral side of the front cover. After at least one fastening element is tightened into the at least one fastening hole, the front cover and the backlight unit are combined together through the at least one fastening element.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A and FIG. 1B (prior art) schematically illustrate the applications of display modules;

FIG. 2A (prior art) is a schematic perspective view illustrating a conventional display module;

FIG. 2B (prior art) is a schematic cross-sectional view illustrating the structure of the display module shown in FIG. 2A and taken along the line AB;

FIG. 3 (prior art) is a schematic cross-sectional view illustrating a process of screwing the display module on the fixing bracket according to prior art;

FIG. 4A is a schematic perspective view illustrating a display module according to an embodiment of the present invention;

FIG. 4B is a schematic cross-sectional view illustrating the structure of the display module shown in FIG. 4A and taken along the line CD; and

FIG. 5 is a schematic cross-sectional view illustrating a process of screwing the display module on the fixing bracket according to the embodiment of the present invention.

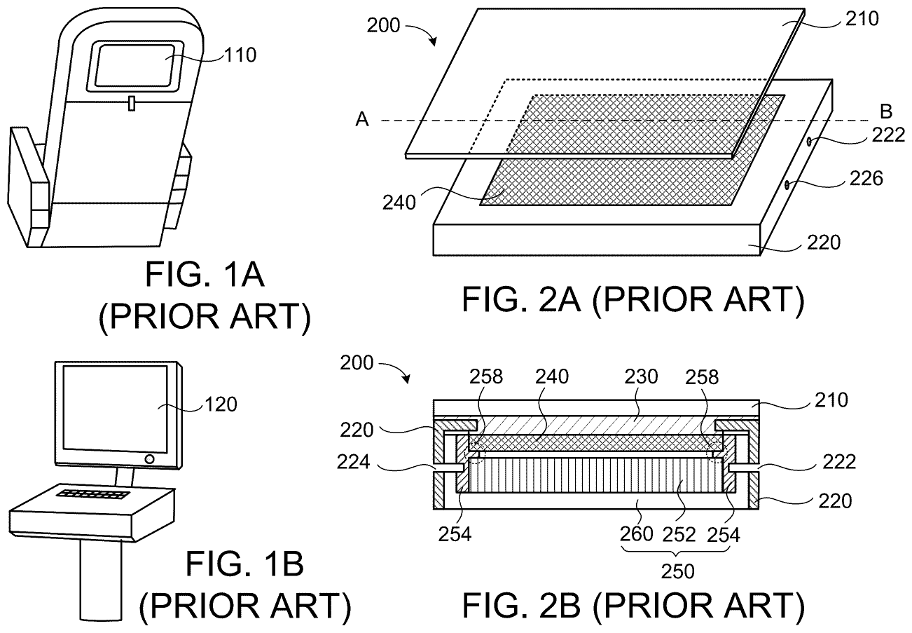

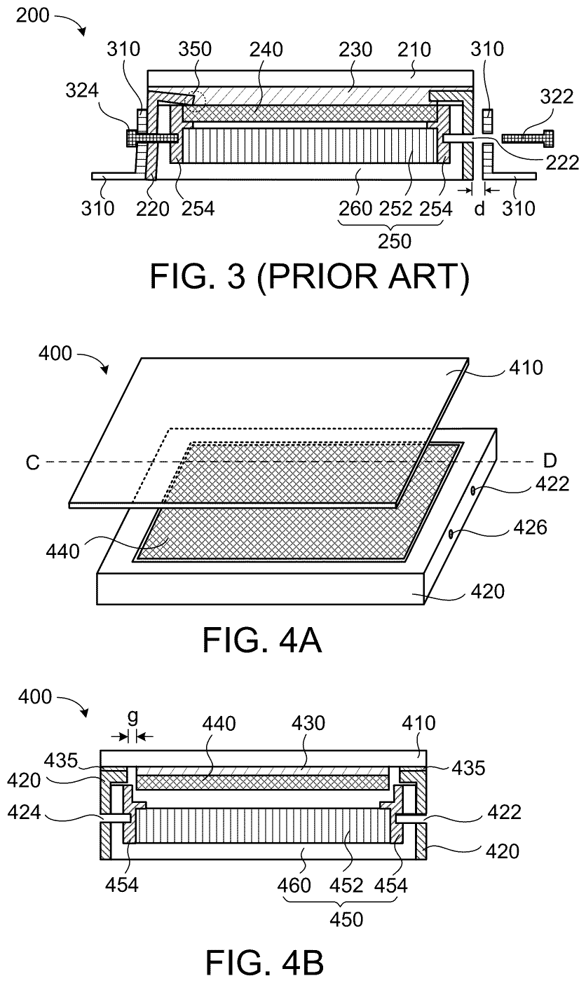

### DETAILED DESCRIPTION OF PREFERRED EMBODIMENTS

Please refer to FIGS. 4A and 4B. FIG. 4A is a schematic perspective view illustrating a display module according to an embodiment of the present invention. FIG. 4B is a schematic cross-sectional view illustrating the structure of the display module shown in FIG. 4A and taken along the line CD. The display module 400 includes a front cover 420, a backlight unit 450, an LCD panel 440, a cover lens 410, an optical clear resin (OCR) 430 and an adhesive material 435. The LCD panel 440 is an in-plane-switching liquid crystal panel (also referred as an IPS panel). The front cover 420 is a metal front cover. The materials of the optical clear resin (OCR) 430 and the adhesive material 435 are identical or different. For example, the adhesive material 435 is a glue or a double sided tape. The backlight unit 450 includes a heat sink 460, a backlight source 452 and a frame 454. The frame 454 is a plastic frame. The sidewall of the backlight source 452 is surrounded by the frame 454.

In the display module 400 of this embodiment, the front cover 420 and the LCD panel 440 are specially designed. That is, the front cover 420 and the LCD panel 440 are not in contact with each other. Consequently, even if the front cover 420 is subjected to the screwing deformation, the displayed image on the LCD panel 440 will not generate the Mura phenomenon. For understanding the concepts of the present invention, the structure of the display module 400 will be described as follows.

As shown in FIG. 4B, in the backlight unit 450, the backlight source 452 is in contact with the bottom surface of the concave structure of the heat sink 460. The frame 454 is in contact with the inner sidewall of the heat sink 460. Furthermore, the LCD panel 440 is placed on the upper opening of the frame 454 above the backlight unit 450. The backlight source 452 is arranged between the bottom side of the frame 454 and the bottom surface of the concave structure of the heat sink 460. In other words, the bottom side and the lateral sides of the backlight source 452 are respectively surrounded by the heat sink 460 and the frame 454. Consequently, the light beam emitted by the backlight source 452 can only be projected to the outside of the display module 400 through the LCD panel 440.

In this embodiment, the front cover 420 covers the top side of the heat sink 460. In addition, the lateral sides of the front cover 420 are in contact with the outer sidewall of the heat sink 460. An opening is formed in a surface of the front cover 420. The LCD panel 440 is exposed to the opening. Especially, the front cover 420 is not in contact with the LCD panel 440. That is, there is a spacing interval g between the front cover 420 and the LCD panel 440. Generally, plural fastening holes (e.g., the screw holes 422, 424 and 426) are formed in the lateral sides of the front cover 420. After corresponding fastening elements such as screws (not shown) are penetrated through the screw holes 422, 424 and 426, the screws are penetrated through the heat sink 460 and tightened into the frame 454 of the backlight unit 450. In other words, the front cover 420 and the backlight unit 450 are combined together through the screws.

In order to protect the LCD panel 440, the cover lens 410 can be used to cover the top side of the front cover 420 and the top side of the LCD panel 440. A purpose of the present invention is to reduce the interaction between the front cover 420 and the LCD panel 440. As shown in FIG. 4B, the adhesive material 435 is applied to the top surface of the front cover 420, and the optical clear resin (OCR) 430 is applied to the top surface of the front cover 420 of the LCD panel 440, and then the resulting structure is covered with the cover lens 410. When the resulting structure is covered with the cover lens 410, the adhesive material 435 and the optical clear resin (OCR) 430 are not in contact with each other. Consequently, the cover lens 410 is adhered on the front cover 420 through the adhesive material 435, and the LCD panel 440 is adhered on the cover lens 410 through the optical clear resin (OCR) 430. That is, after a first portion and a second portion of the cover lens 410 are respectively adhered on the top surface of the front cover 420 and the top surface of the LCD panel 440 through the adhesive material 435 and the optical clear resin (OCR) 430, the display module 400 is completed.

As mentioned above, the display module 400 includes plural screw holes 422, 424 and 426. After the display module 400 is placed on a fixing bracket (not shown), the display module 400 can be fixed on the fixing bracket through screws (not shown). For example, the back of an airplane seat, the main body of a medical instrument or an automobile panel can be used as the fixing bracket. The types and applications of the fixing bracket are well known to those skilled in the art, and not redundantly described herein.

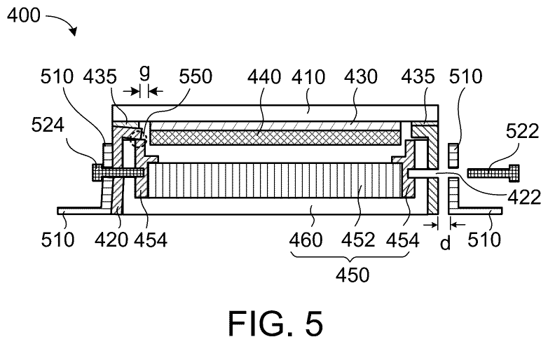

FIG. 5 is a schematic cross-sectional view illustrating a process of screwing the display module on the fixing bracket according to the embodiment of the present invention. Firstly, the display module 400 shown in FIG. 4B is placed on a fixing bracket 510. Then, screws 522 and 524 are penetrated through corresponding screw holes of the fixing bracket 510 and the screw holes 422 and 424 and tightened into the front cover 420 by the operator. Similarly, there is a tolerance gap d between the fixing bracket 510 and the display module 400. Due to the tolerance gap d, the front cover 420 is possibly pulled in response to the stress on the fixing bracket 510 when the display module 400 is screwed on the fixing bracket 510. Consequently, the fixing bracket 510 and the front cover 420 will be suffered from the screwing deformation problem.

As shown in FIG. 5, the front cover 420 is not in contact with the LCD panel 440, and there is the spacing interval g between the front cover 420 and the LCD panel 440. In case that the front cover 420 is suffered from the screwing deformation problem, the front cover 420 will exert a greater force on a force-receiving point 550. The force-receiving point 550 is at the heat sink 460 or the frame 454. That is, even if the front cover 420 is subjected to deformation, the front cover 420 cannot be contacted with the LCD panel 440. When the display module 400 is operated, the image on the LCD panel 440 can be normally displayed. Since the Mura phenomenon is avoided, the displayed image can be normally viewed.

From the above descriptions, the present invention provides the liquid crystal display module. In the display module, the front cover and the LCD panel are not in contact with each other. Even if the front cover is subjected to the screwing deformation, the extent of the screwing deformation of the front cover is still within the spacing interval between the front cover and the LCD panel. Since the front cover subjected to the screwing deformation does not exert the pressure on the LCD panel, the Mura phenomenon can be avoided. In other words, the display module of the present invention is industrially valuable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A liquid crystal display module, comprising:
a backlight unit comprising a heat sink, a backlight source and a frame, wherein a lateral side of the backlight source is surrounded by the frame, the backlight source is in contact with a surface the heat sink, and the frame is in contact with an inner sidewall of the heat sink;
An LCD panel disposed above the backlight unit;
a front cover covering a top side of the heat sink and a top side of the frame, wherein a lateral side of the front cover is in contact with an outer sidewall of the heat sink, an opening is formed in the front cover, and the LCD panel is exposed to the opening, wherein the front cover is not in contact with the LCD panel; and
a cover lens covering a top side of the front cover and a top side of the LCD panel, wherein the cover lens is adhered on the front cover through an adhesive material, and the LCD panel is adhered on the cover lens through an optical clear resin,
wherein at least one fastening hole is formed in the lateral side of the front cover, wherein after at least one fastening element is tightened into the at least one fastening hole, the front cover and the backlight unit are combined together through the at least one fastening element.

2. The liquid crystal display module as claimed in claim 1, wherein the adhesive material is a glue or a double sided tape.

3. The liquid crystal display module as claimed in claim 1, wherein after the at least one fastening element is penetrated through the at least one fastening hole, the at least one fastening element is penetrated through the heat sink and tightened into the frame of the backlight unit.

4. The liquid crystal display module as claimed in claim 1, wherein the heat sink includes a concave structure, and the backlight source is disposed within the concave structure, wherein a bottom side of the backlight source and the lateral side of the backlight source are respectively surrounded by the heat sink and the frame, so that a light beam emitted by the backlight source is only permitted to be projected to an outside of the display module through the LCD panel.

5. The liquid crystal display module as claimed in claim 1, wherein the display module is placed on a fixing bracket.

6. The liquid crystal display module as claimed in claim 5, wherein after the at least one fastening element is penetrated through at least one fastening hole of the fixing bracket and the at least one fastening hole of the display module, the display module is fixed on the fixing bracket.

7. The liquid crystal display module as claimed in claim 6, wherein when the display module is fixed on the fixing bracket, the fixing bracket and the front cover are subjected to a screwing deformation, wherein when the front cover is contacted with the heat sink or the frame in response to the screwing deformation, the front cover is not in contact with the LCD panel.

8. The liquid crystal display module as claimed in claim 1, wherein the adhesive material and the optical clear resin are not in contact with each other.
